(19) United States
(12) Patent Application Publication
(10) Pub. No.: US 2011/0099337 A1
(43) Pub. Date: Apr. 28, 2011

(54) PROCESSING CIRCUIT WITH CACHE CIRCUIT AND DETECTION OF RUNS OF UPDATED ADDRESSES IN CACHE LINES

(75) Inventors: Jan Hoogerbrugge, Helmond (NL); Andrei Sergeevich Terechko, Eindhoven (NL)

(73) Assignee: NXP B.V., Eindhoven (NL)

(21) Appl. No.: 12/999,542

(22) PCT Filed: Jun. 10, 2009
(86) PCT No.: PCT/IB09/52463

§ 371 Date: Dec. 16, 2010

(30) Foreign Application Priority Data
Jun. 17, 2008 (EP) 08158431.0

(51) Int. Cl. G06F 12/08

(52) U.S. Cl. 711/143; 711/E12.017

(57) ABSTRACT

A circuit that comprises a processor core (100), a background memory (12) and a cache circuit (102) between the processor core (100) and the background memory (12). In operation a sub-range of a plurality of successive addresses is detected within a range of successive addresses associated with a cache line, the sub-range containing addresses for which updated data is available in the cache circuit. Updated data for the sub-range is selectively transmitted to the background memory (12). A single memory transaction for a series of successive addresses may be used, the detected sub-range being used to set the start address and a length or end address of the memory transaction. This may be applied for example when only updated data is available in the cache line, and no valid data for other addresses, or to reduce bandwidth use when only a small run of addresses has been updated in the cache line.

### FIELD OF THE INVENTION

The invention relates to a system with a cache memory, to a method of operating a system and to a compiler for such a system.

### BACKGROUND OF THE INVENTION

It is known to provide a cache memory between a processor and a background memory. The cache memory stores copies of data associated with selected addresses in the background memory. When the processor updates data for a background memory address in its cache memory, the updated data needs to be written back to the background memory. Typically, this is done by copying back cache lines containing the updated data from the cache memory to the background memory.

In the case of a multiprocessor system, with a plurality of processors that each have a respective cache coupled between it and the background memory, the other processors have to re-read cache lines containing the updated data from the background memory, or, at the expense of more complicated cache design, they have to snoop on communication between the updated cache memory and the background memory in order to capture updated data values.

This form of copyback occupies substantial memory bandwidth. The use of individual write transactions for individual updated words may consume a significant number of write cycles. Fortunately, modern memories also support larger write transactions. This may be used to write a cache line as a whole as a single write transaction, to avoid the overhead of individual write transactions for individual updated words. However, cache line write back still takes up considerable memory bandwidth. Moreover, in the case of a multiprocessor system cache line write back may further increase memory bandwidth use due read back from background memory.

### SUMMARY OF THE INVENTION

Among others, it is an object to reduce the memory bandwidth for writeback of updated cache data.

A processing circuit according to claim 1 is provided. Herein a writeback circuit controls write back of updated data from a cache circuit to a background memory interface. The writeback circuit is configured detect a “run” of addresses in a cache for selective transmission back to the background memory. The “run” is a sub-range of addresses associated with a cache line between addresses in the cache line for which no updated data is available in the cache circuit. Thus bandwidth is saved.

In an embodiment a memory transaction that specifies a start address and a length determined from the detected sub-range may be used. This saves bandwidth.

In an embodiment the writeback circuit is configured to detect the sub-range subject to the condition that the sub-range contains only addresses in the cache line for which updated data is available in the cache circuit. This may be used to support low bandwidth write back from a cache line wherein data has been updated without first loading data from the background memory. By writing back a run from the cache line that contains only updated data, a fast write back is possible without overwriting unchanged data. When there is no single continuous run of updated addressed, in various embodiments a plurality of runs may be used, or alternatively updated data words for individual addresses can be written back or data can be loaded from background memory first to fill up gaps.

In an embodiment information defining a run is maintained while the cache line is used by updating the data each time when the processor core performs a write to a cache line. Thus, no delay is needed on write back to detect runs. In an embodiment memories (that is, distinct memory circuits or areas of one larger memory) may permanently be provided for maintaining information about runs for all combinations of sets and ways. In other embodiments such memories may be allocated dynamically to combinations of sets and ways that are updated. This saves circuit area. When updates are sufficiently infrequent no more memory is needed. If under some circumstances insufficient memories are available for run information for all cache lines that are updated, a standard more bandwidth intensive writeback treatment may be given to cache lines for which no memory is available.

### BRIEF DESCRIPTION OF THE DRAWINGS

These and other objects and advantageous aspects will become apparent from a description of exemplary embodiments, using the following Figures.

FIG. 1 shows a multiprocessing system

FIG. 2 shows a circuit for maintaining information about a sub-range

FIG. 3 shows a circuit for maintaining information about a sub-range

FIG. 4 shows a multiprocessing system

### DETAILED DESCRIPTION OF EXEMPLARY EMBODIMENTS

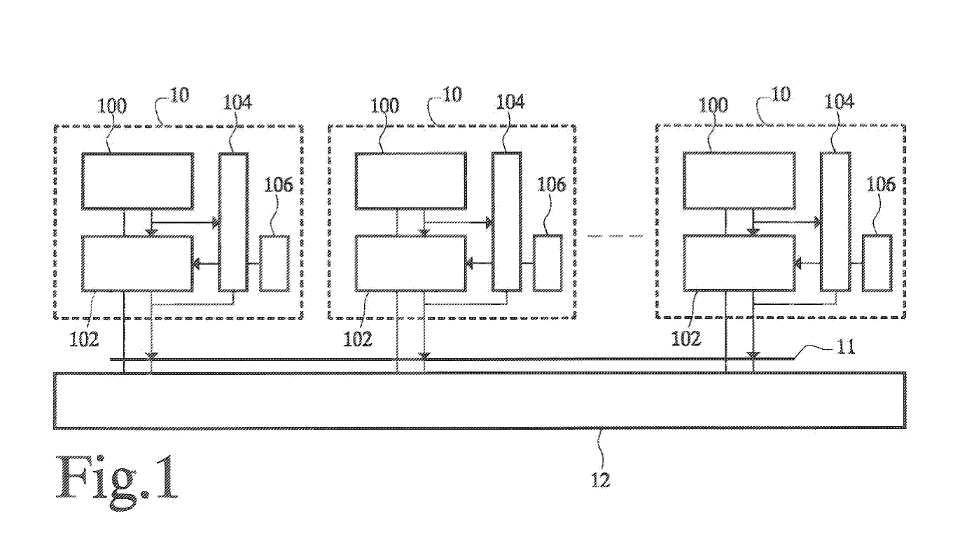

FIG. 1 shows a multiprocessing system, comprising a plurality of processing elements 10 and a background memory 12. The processing elements 10 are coupled to background memory via a memory interface 11. Each processing element 10 comprises a processor core 100, a cache circuit 102, a writeback circuit 104 and a run memory 106.

The cache circuit 102 of each processing element 10 is coupled between the processor core 100 of the processing element 10 and background memory 12. The cache circuit 102 may comprise a cache memory and a control circuit, arranged to test whether data addressed by commands from processor core 100 is present in the cache memory and to return data from the cache or load data from background memory dependent on whether the data is present. Although writeback circuit 104 is shown separately, it may be part of the control circuit of cache circuit 102.

Writeback circuit 104 has an input coupled to an address/command output from processsor core 100 to cache circuit 102. Furthermore writeback circuit 104 is coupled to cache circuit 102, to background memory 12 and to run memory 12.

In operation, processor cores 100 execute respective programs with load and store commands that address locations in background memory 12. Copies of the data for those addresses are stored in cache circuits 102. In the case of a load command, the addressed data may be copied from background memory 12 to cache circuit 102 in the form of a cache line with data for a plurality of consecutive addresses. In the case of a store command data may be updated in a cache line in a cache circuit 102 after copying the original data from background memory 12. Alternatively, stored data may be kept in cache without first loading the surrounding cache line. In this case cache circuit 102 keeps a record of the locations in the cache line where updated data has been stored.

After the execution of store operations writeback circuit 104 writes back data from cache circuit 102 to background memory. In order to prepare for writeback, writeback circuit 104 maintains information in run memory 106 about a sub-range of addresses that must be written back. In an embodiment run memory 106 stores information indentifying the start and end of such a sub-range for each cache line that is stored in cache circuit 102, and optionally a flag to indicate whether the sub-range is enabled. Writeback circuit 104 monitors the output of the processor core to detect a write operation to cache circuit 102 and to obtain the write address of that operation. Writeback circuit 104 determines the cache line that contains the write address and compares the write address with the start and end of the sub-range for that cache line. If the write address is outside the sub-range writeback circuit 104 updates the information for the cache line in the run memory 106, to extend the sub-range so that it extends to the write address.

Subsequently, when write back to background memory 12 is needed, writeback circuit 104 uses the information about start and end addresses to select data from cache circuit 102 that will be written back to background memory 12. In an embodiment, writeback circuit 104 writes back data starting from data for the start address and ending with data for the end address from cache circuit 102 to background memory 12.

Writeback may be triggered for example by a command from the program of the processor core 100, or by the controller of cache circuit 102 if the controller evicts a cache line from the cache circuit to make room for another cache line.

When triggered writeback circuit 104 may start a multi-word memory transaction via memory interface 11, supplying a transaction start address and a transaction length control word to memory interface 11 based on the information from run memory 106.

In this embodiment writeback circuit 104 controls cache circuit 102 to supply cached data words to memory interface 11, from addresses in the relevant cache line starting from the start address and ending with the end address. If memory interface 11 imposes conditions on the start addresses of memory transactions and/or their length, for example requiring that the addresses are aligned to addresses wherein the least significant n bits are zero, with n=2 for example, writeback circuit 104 may extend the sub-range to align it with such transaction boundaries. This may be done when information in run memory 106 is updated, or when writeback circuit 104 uses the information from run memory to form the memory transaction. Upon writeback the start and end information is reset if the cache line remains allocated to the same background memory addresses, so that an empty sub-range of updated write-addresses is indicated. The start and end information is also reset when the cache line is newly allocated to a range of memory addresses.

The use of write transactions for a sub-range within a cache line has the advantage that memory write transactions may be shortened, by limiting to a part of the cache line wherein actual updates have occurred since the cache line was allocated, or since it was last written back. Although it is preferred that the start and end are set to point to the first and last updated data, they may refer to a wider sub-range within a cache line. Although this may lead to unnecessary write back, it still presents a gain compared to writing back an entire cache line when only part of the data in the cache line has been updated.

In an embodiment wherein cache circuit 102 is configured to allocate cache lines for writing without first loading the cache line from background memory 12. In this embodiment the cache circuit 102 of a processing element 10 marks the data that the processor core 100 of the processing element 10 has written into the cache line. When the processor core 100 reads data from the cache circuit 102, the cache circuit 102 tests whether the data has been written first. If not, the cache circuit 102 triggers a read from background memory 12, optionally preceded by a writeback of the updated data. In the case of a read without prior writeback the cache circuit 102 enters only the background memory data for addresses in the cache line that have not yet been written by the processor core 100.

In this embodiment a selective writeback may be needed, involving only the addresses from a cache line that have been written by the processor core 100. In this case, writeback circuit 104 only writes back a sub-range if it does not contain any “gaps”: addresses where no data has been written. If writeback circuit 104 detects a gap, it may use memory transactions for individual write addresses, instead of using a memory transaction for a sub-range.

Writeback circuit 104 may be combined with the control circuit of cache circuit 102. For example, it may share circuits for translating background memory addresses into selection of cache lines and it may receive writeback trigger signals from the control circuit. Similarly, run memory 106 may be combined with cache lines.

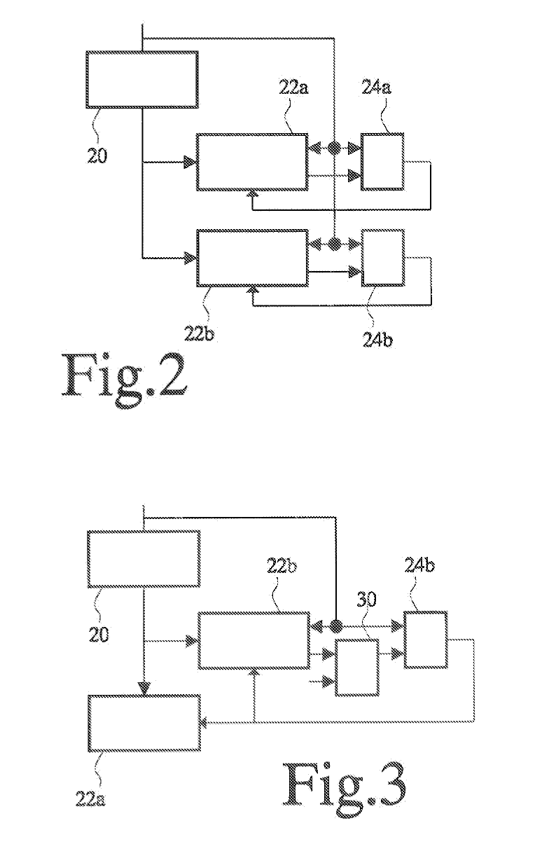

FIG. 2 shows a simple example of an embodiment of circuitry to perform the function of maintaining information about the start and end points. The circuitry comprises an address translation circuit 20, a start address memory 22a, an end address memory 22b and a first and second comparator 24a,b. Address translation circuit 20 has an input coupled to the address command output of the processor core (not shown) and an output coupled to address inputs of start address memory 22a and end address memory 22b. Start address memory 22a and end address memory 22b have outputs coupled to first comparator inputs of first and second comparator 24a,b respectively and data inputs coupled to an input of the address command output of the processor core (not shown). First and second comparator 24a,b have outputs coupled to write control inputs of start address memory 22a and end address memory 22b respectively.

Address translation circuit 20 receives part of the write address supplied from the address/command output of the processor core (not shown) to the cache circuit (not shown) and translates it to a cache line selection address. In an n-way set associative cache for example, this may involve using a tag part of the write address to select a set and an associative memory to select a cache way based on the write address. Part or all of address translation circuit 20 may also serve to select cache lines in the cache circuit (not shown).

Address translation circuit 20 supplies the cache line selection address to start address memory 22a and end address memory 22b. Start address memory 22a and end address memory 22b store start and end addresses of sub-ranges of updated addresses for respective cache lines and optionally flags to indicate whether the sub-ranges are active. In response to the cache line selection address start address memory 22a and end address memory 22b supply start and end addresses stored for the cache line that is selected by the write address. First and second comparator 24a,b compare the stored addresses with an intra cache line address part of the write address from the address command output of the processor core (not shown). If the comparison indicates that the intra cache line address part is lower than the stored start value first comparator 24a controls start address memory 22a to replace the start address for the cache line by the intra cache line address part from the address command output of the processor core (not shown). Similarly, if the comparison indicates that the intra cache line address part is higher than the stored start value second comparator 24a controls end address memory 22a to replace the end address for the cache line by the intra cache line address part from the address command output of the processor core (not shown).

It should be appreciated that the circuit of FIG. 2 is merely one example of a circuit to perform the function of updating the information about start and end addresses. For example, alternatively a start address and a length may be stored to represent information about the start and end, defining the end as a sum of the start address and the length. Arithmetic circuits may then be used to convert addresses. A programmable controller may be used to update the memories and a single memory may be used to store both start and end, or other information, the comparators selecting which should be updated.

In the case that writeback may occur for a cache line with “gaps”, that is, a cache line wherein data has been written by the processor core 100 without first copying the cache line from background memory 12, it may be needed to transmit enable information in the memory transaction to indicate selected data that must be used to update the background memory 12. Correspondingly, background memory 12 may be configured to receive such enable information and to enable only data for background addresses that have been indicated by this information. In another embodiment, these measures may be made unnecessary by configuring writeback circuit 104 to use memory transactions for sub-ranges of cache lines only if the data in the cache line has first been loaded and/or by using memory transactions for sub-ranges only if there are no gaps, memory transactions for individual addresses being used otherwise.

FIG. 3 shows an embodiment wherein sub-ranges are maintained only when successive adjacent write addresses are used, in order to prevent gaps. In this case, start memory 22a may be configured to store flags indicating whether a valid start address is stored and whether write back of a sub-range is enabled. Start memory 22a is configured to enable storing the write address both as start and end address when a write address is received while the flags indicate that this is a first received address in the cache line. Subsequently, second (only) comparator 24b detects whether the received write address is equal to the end address plus an increment added by an adder 30. If so, the end address is updated. Otherwise, the flag in start memory 20a for the cache line may be set to a value to disable write back of a sub-range in the cache line.

The increment may be equal to a write length of the command of the processor core 100 that produced the write address, e.g. to a one word increment. This increment may have a predetermined value, which is the same for all write addresses, or it may be controlled dependent on information from the processor core 100 indicating the type of command. On writeback to background memory 12 when this flag is so set, the writeback circuit 104 causes write back of the entire cache line.

As described, the circuit may be used for an n-way set associative cache circuit 102. In this case, memory for information about the start and end may be stored for all ways of all sets. Alternatively, information defining start and end for only one way in respective sets may be stored. In this embodiment, writeback circuit is configured to store an indication of the way to which the start and end apply. This embodiment is based on the insight that writing to cache lines may be so infrequent that concurrent writing to a plurality of ways in the same set occurs infrequently. If it occurs, writeback circuit 104 writes back the cache lines entirely from the ways for which no start and end information is stored.

In another embodiment a pool of start end information block may be used for all sets and ways. In this case address translation circuit 20 may comprise an associative memory to select memory locations allocated to a write address and to allocate such locations to cache lines until they have been written back.

In a further embodiment run memory 106 may be configured to store information about a plurality of start-end sub-ranges of the same cache line. Thus for example writeback circuit 104 may be configured to test each received write address in a cache line to determine whether it is equal to the previous write address plus the write length and if so to raise the end of the current sub-range and, if not, to start a next sub-range. If the number of sub-ranges that has been started in this way exceeds a maximum writeback circuit 104 may set a flag to disable write back of sub-ranges. On writeback to background memory 12 when this flag is so set, the writeback circuit 104 causes write back of the entire cache line. In a further embodiment, a single write transaction may be performed starting from the beginning address of the lowest sub-range in the cache line to the end address of the highest sub-range, using disable/enable signals in the write transaction to enable writing selectively for those addresses that lie in the sub-ranges. A test may be performed before this write transaction to select between such a write transaction or a write transaction for the entire cache line, whichever is more efficient.

Although an embodiment has been shown wherein the information about the start and end of the sub-ranges is updated in response to write addresses, so that it is up to date when writeback is needed, it should be appreciated that alternatively writeback circuit 104 may gather this information from cache circuit 102 after receiving trigger signal to perform write back.

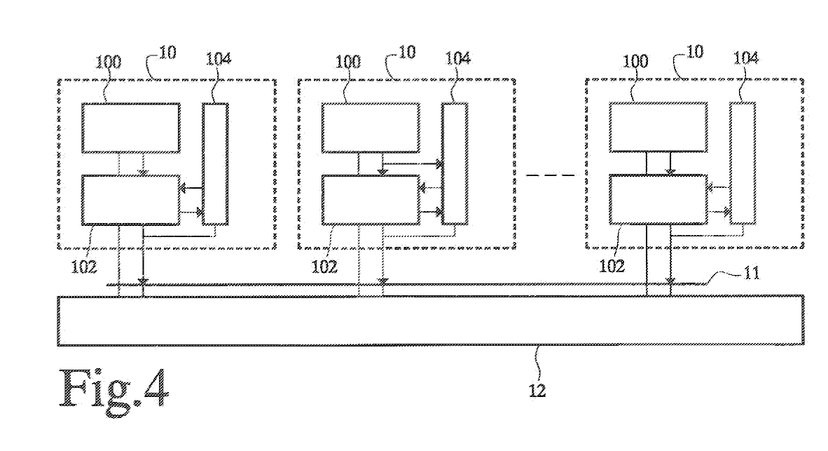

FIG. 4 shows an embodiment of the processing system wherein such post processing is used. Herein cache circuit 102 is configured to maintain “dirty bits” for respective locations in a cache line to indicate whether the data in these location has been updated. On receiving a trigger signal to perform writeback for a cache lines, writeback circuit 104 reads these dirty bits for the cache line and determines a sub-range of addresses that have been updated. Subsequently writeback circuit 104 performs writeback using a memory transaction defined by the sub-range.

This may be performed in pipelined operation, i.e. execution of the writeback function may be divided into a plurality of stages that are executed in different execution cycles. In a first stage, effective addresses are computed. In a second stage cache tags are inspected to determine whether the cache line is in cache and to determine the cache way in which it is stored. These stages are also performed for conventional writeback. In a third stage a sub-range of the cache line containing all addresses with updated data is determined, and it is decided whether the size of this sub-range is below a threshold that ensures faster write back. In a fourth stage the data is written with a transaction for the range, or in a conventional way, according to the decision. As will be appreciated, this method may have the disadvantage that it may increase the latency of write back and slow down multi-processing. It has the advantage that the circuit is simplified.

Although an embodiment has been shown wherein the processing system is a multiprocessor system, it should be appreciated that writeback of a sub-range may also be applied to a system with a single processing element. However, in a multiprocessor system the background memory bandwidth is often more stressed. In addition the sub-range writeback may simplify snooping. When snooping is used the cache circuits 102 of the processing elements monitor writeback memory transactions from other processors. When a cache circuit 102 detects a writeback for a sub-range of a cache line from another cache circuit 102, the detecting cache circuit 102 may use information from this memory transaction to update a sub-range of the cache line in the detecting cache circuit 102. Instead of snooping, synchronization between the processing elements may be used to stall processing elements from starting execution of program portions that use shared data until other processor elements have released the shared data. Before releasing the shared data may be written back to background memory 12 it has been modified, so that the modified shared data may be read back from background memory by the processor element that starts using the shared data. In this case, writeback of sub-ranges reduces the size of writeback bursts at synchronization points.

Although background memory 12 has been shown as part of the system, it should be appreciated that a part of the system excluding the background memory may be implemented in an integrated circuit that does not contain the background memory 12, but only the memory interface 11. In this case the background memory 12 mat be implemented on one or more external integrated circuits.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A processing circuit, comprising:
a processing element with an interface to a background memory, the processing element comprising:
a processor core;
a cache circuit coupled between the processor core and the interface to the background memory; and
a writeback circuit configured to control write back of updated data from the cache circuit to the interface to the background memory, the writeback circuit being configured to detect a sub-range of a plurality of successive addresses within a range of successive addresses associated with a cache line, the sub-range containing addresses in the cache line for which updated data is available in the cache circuit and the sub-range lying between addresses in the cache line for which no updated data is available in the cache circuit, and to selectively cause transmission of data for the sub-range to the background memory.

2. A processing system according to claim 1, wherein the writeback circuit is configured to transmit the data as part of a memory transaction for a series of successive addresses, the memory transaction specifying a start address and an end address or a length of the series determined from the detected sub-range.

3. A processing system according to claim 1, further comprising at least one of a sub-range memory and a memory area for representing the sub-range, the writeback circuit being configured to monitor write addresses passed by the processor core when executing write commands to the cache memory, to compare each of the write addresses, when received, to the represented sub-range if present in the sub-range memory or memory area, and to extend the sub-range in the sub-range memory each time when the write address lies outside the represented sub-range.

4. A processing system according to claim 3, further comprising at least one of a plurality of sub-range memories and a plurality of memory areas each for a respective set and way of the cache circuit.

5. A processing system according to claim 3, further comprising at least one of a plurality of sub-range memories and a plurality of memory areas each for a respective set in common for all ways in the set, for representing a single sub-range for the respective set, the writeback circuit being configured to allocate the sub-range memory or memory area for the set to a first updated way in the set.

6. A processing system according to claim 1, further comprising at least one of a plurality of associative sub-range memories and a plurality of memory areas, the writeback circuit being configured to create associations between respective ones of the sub-range memories or memory areas and respective combinations of a set and way dynamically at run time.

7. A processing system according to claim 1, wherein the write-back circuit is configured to operate as a writeback command post-processor, the post-processor being configured to identify the sub-range upon receiving a writeback command for the cache line to write the cache line back to the background memory, from data indicating whether respective addresses in the cache line have been updated.

8. A processing system according to claim 1, wherein the writeback circuit is configured to detect the sub-range subject to the condition that the sub-range contains only addresses in the cache line for which updated data is available in the cache circuit.

9. A processing system according to claim 1, wherein the writeback circuit is configured to write back words of updated data from the cache line selectively to the background memory upon detection of an address in the cache line for which no updated data is available in the cache circuit between addresses in the cache line for which updated data is available in the cache circuit and the writeback circuit is configured to transmit the data as part of a memory transaction for a series of successive addresses, the memory transaction specifying a start address and a length or start address of the series determined from the detected sub-range when the sub-range contains only addresses in the cache line for which updated data is available in the cache circuit.

10. A processing system according to claim 1, wherein the writeback circuit is configured to transmit the data as part of a memory transaction for a series of successive addresses, the memory transaction specifying a start address and a length or start address of the series determined from the detected sub-range when the sub-range contains only addresses in the cache line for which updated data is available in the cache circuit and the writeback circuit is configured to respond to detection of an address in the cache line for which no updated data is available in the cache circuit between addresses in the cache line for which updated data is available in the cache circuit, by loading data for the address in the cache line for which no updated data is available in the cache circuit from memory and writing back the loaded data with the updated data.

11. A processing system according to claim 2, wherein the writeback circuit is configured to detect a plurality of sub-ranges within a same cache line, each of a respective plurality of successive addresses within a range of successive addresses associated with said same cache line, each sub-range containing only addresses in the cache line for which updated data is available in the cache circuit and to enable respective write transactions for each of the sub-ranges.

12. A method of processing data with a circuit that comprises a processor core, a background memory and a cache circuit between the processor core and the background memory, the method comprising:
detecting a sub-range of a plurality of successive addresses within a range of successive addresses associated with a cache line, the sub-range containing addresses in the cache line for which updated data is available in the cache circuit and the sub-range lying between addresses in the cache line for which no updated data is available in the cache circuit; and
selectively transmitting data for the sub-range to the background memory.

13. A method according to claim 12, further comprising transmitting the data as part of a memory transaction for a series of successive addresses, the memory transaction specifying a start address and a length or end address determined from the detected sub-range.

14. A method according to claim 13, wherein the sub-range contains only addresses in the cache line for which updated data is available in the cache circuit, said transmitting of the sub-range being disabled when a gap with not-updated addresses is present between addresses in the cache line for which updated data is available in the cache circuit.
